(19) United States
(12) Patent Application Publication
(10) Pub. No.: US 2024/0294343 A1
(43) Pub. Date: Sep. 5, 2024

(54) TOTE TIPPING SYSTEM

(71) Applicant: Material Handling Systems, Inc., Mt. Washington, KY (US)

(72) Inventors: Michael Thomas Fleming, Waxhaw, NC (US); Caner Oktayer, West Babylon, NY (US); Paul Receveur, New Albany, IN (US)

(21) Appl. No.: 18/592,801

(22) Filed: Mar. 1, 2024

Related U.S. Application Data
(60) Provisional application No. 63/488,231, filed on Mar. 3, 2023.

(51) Int. Cl. B65G 65/23

(52) U.S. Cl. CPC B65G 65/23

(57) ABSTRACT

A tote tipping system including a frame extending from a first (lower) end to a second (upper) end, a tote support fixture configured to selectively engage and secure a tote, and a drive mechanism configured to move the tote support fixture between the first end of the frame and the second end of the frame. When the tote support fixture is at the first end of the frame, the tote support fixture is at a first angular orientation relative to the frame, and when the tote support fixture is at the second end of the frame, the tote support fixture is at a second angular orientation relative to the frame. In the first angular orientation, a tote can be secured to the tote support fixture, and, in the second angular orientation, parcels fall out of the tote under the force of gravity

### CROSS-REFERENCE TO RELATED APPLICATIONS

The present application claims priority to U.S. Patent Application Ser. No. 63/488,231 filed on Mar. 3, 2023, the entire disclosure of which is incorporated herein by reference.

### BACKGROUND OF THE INVENTION

In a sorting facility for parcels, various parcels are unloaded from trucks or other vehicles at unloading locations, sorted, and then loaded onto trucks or other vehicles at loading locations for delivery to the intended recipients. Thus, within the sorting facility, there is often a complex system of conveyors and equipment that facilitates transport and sorting of the various parcels within the facility.

In some systems of known construction, parcels come off of sorters directly into bags. However, this often requires that operators continuously walk the perimeter and gather up the bags full of parcels and set up replacement empty bags.

Furthermore, to improve the sorting of parcels into bags, totes are often utilized. Such totes are configured hold multiple parcels during the sorting and transport of the parcels. While the specific design of the tote is not limited, the totes are typically box-like and substantially rigid. The totes may include specific features which assist in the movement and manipulation of the totes, such as handles, indentations, channels configured for mechanical coupling, and/or metal panels for electromagnetic coupling. In use, each tote is generally positioned adjacent to a conveyer or other similar piece of equipment for moving parcels, with the parcels then being moved from the conveyor into the tote for transport to a new destination within the facility. Transportation of the totes throughout the facility may be accomplished through a variety of means known in the art including but not limited to conveyers, autonomous guided vehicles (AGVs), and/or autonomous mobile robots (AMRs). Upon reaching the new destination, it is sometime advantageous to tip the tote such that all of the parcels contained within the tote are dumped onto a specified location, such as a chute to fill a bag.

### SUMMARY OF THE INVENTION

The present invention is a tote tipping system, including a frame extending from a first (lower) end to a second (upper) end, a tote support fixture configured to selectively engage and secure a tote, and a drive mechanism configured to move the tote support fixture between the first end of the frame and the second end of the frame. When the tote support fixture is at the first end of the frame, the tote support fixture is at a first angular orientation relative to the frame, and when the tote support fixture is at the second end of the frame, the tote support fixture is at a second angular orientation relative to the frame. In the first angular orientation, a tote can be secured to the tote support fixture, and, in the second angular orientation, parcels fall out of the tote under the force of gravity

In some embodiments, the frame includes a rail extending between the first end and the second end of the frame, wherein the tote support fixture moves along the rail.

In some embodiments, the rail is substantially straight along a majority of a length of the frame.

In some embodiments, the rail includes a curved section at the second end of the frame, such that, as the tote support fixture moves along the curved section of the rail, the tote support fixture rotates from the first angular orientation to the second angular orientation.

In some embodiments, the system further includes a travelling connector interposed between the tote support fixture and the frame, and the travelling connector engages and moves along the rail.

In some embodiments, the travelling connector includes a guide member defining a channel configured to engage the rail to facilitate movement of the travelling connector along the rail.

In some embodiments, the system further includes a motor affixed to the travelling connector, the motor being configured to rotate the tote support fixture between the first angular orientation and the second angular orientation.

In some embodiments, the travelling connector includes a main body with wheels extending from the main body, and the wheels are configured to travel along one or more grooves defined along a length of the rail.

In some embodiments, the frame includes two parallel panels. A first rail is affixed to a first of the two panels and a second rail is affixed to a second of the two panels. The first and second rails are positioned between the two parallel panels and the travelling connector is located between the first and second rails.

In some embodiments, the frame defines a serpentine slot, and the travelling connector includes a cam follower configured to engage the serpentine slot. As the travelling connector moves from the first end of the frame to the second end of the frame, the cam follower moves along the serpentine slot, causing the tote support fixture to rotate from the first angular orientation to the second angular orientation.

In some embodiments, the system further includes a motor configured to rotate the tote support fixture between the first angular orientation and the second angular orientation.

In some embodiments, the motor moves along the rail with the tote support fixture.

In some embodiments, the motor rotates the tote support fixture after the tote support fixture is at the second end of the frame.

In some embodiments, the drive mechanism includes a first gear located at the first end of the frame, a second gear located at the second end of the frame, a flexible member extending around and operably connecting the first gear and the second gear, and a motor operably connected to at least one of the first gear and the second gear to rotate the at least one of the first gear and the second gear and cause the flexible member to move. In such embodiments, the tote support fixture is affixed to the flexible member, such that the tote support fixture travels with the flexible member between the first end of the frame and the second end of the frame.

In some embodiments, the flexible member is a chain, but in other exemplary embodiments, the flexible member is a belt.

In some embodiments, the system further includes a counterweight affixed to the flexible member opposite from the tote support fixture.

In some embodiments, the frame includes a first rail extending between the first end and the second end of the frame, and a second rail extending between the first end and the second end of the frame. In such embodiments, the tote support fixture moves along the first rail, and the counterweight moves along the second rail.

In some embodiments, the frame extends at an angle, such that the second end is horizontally offset from the first end, but in other exemplary embodiments, the frame extends vertically, such that the second end is immediately above the first end.

### DESCRIPTION OF THE DRAWINGS

FIG. 1 is a front perspective view of a first exemplary tote tipping system of the present invention;

FIG. 2 is a rear perspective view of the tote support fixture of the tote tipping system of FIG. 1 in isolation;

FIG. 3 is a top partial cross-sectional view illustrating the engagement of the tote support fixture and the rails of the tote tipping system of FIG. 1;

FIG. 4 is a rear perspective view of the tote tipping system of FIG. 1, with one of the panels of the frame removed to show operation of the drive mechanism;

FIG. 5 is a schematic side view illustrating operation of the first exemplary tote tipping system of FIG. 1;

FIG. 6 is a front perspective view of a second exemplary tote tipping system of the present invention;

FIG. 7 is a rear perspective view of the tote tipping system of FIG. 6;

FIG. 8 is a perspective view of the frame and travelling connector of the tote tipping system of FIG. 6 in isolation;

FIG. 9 is a perspective view of the travelling connector of the tote tipping system of FIG. 6 in isolation;

FIG. 10 is a cross-sectional view showing illustrating the engagement of the travelling connector and the rail of the tote tipping system of FIG. 6;

FIG. 11 is a schematic side view illustrating operation of the second exemplary tote tipping system of FIG. 6; and

FIG. 12 is a schematic side view illustrating operation of a third exemplary tote tipping system of the present invention.

### DETAILED DESCRIPTION OF THE INVENTION

The present invention is a tote tipping system configured to receive totes and tip the totes to dispense all of the parcels from the tote. In the discussion that follows and in the claims of the present application, the term “parcel” is not intended to be limiting and can include any article, item, or object that may be transported, loaded, and/or unloaded in the manner specified within the present disclosure.

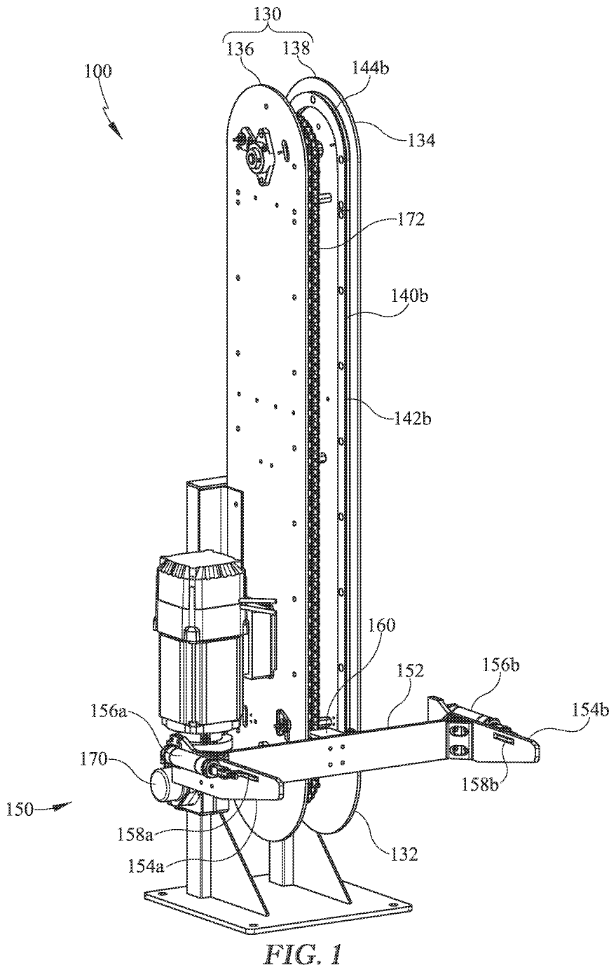

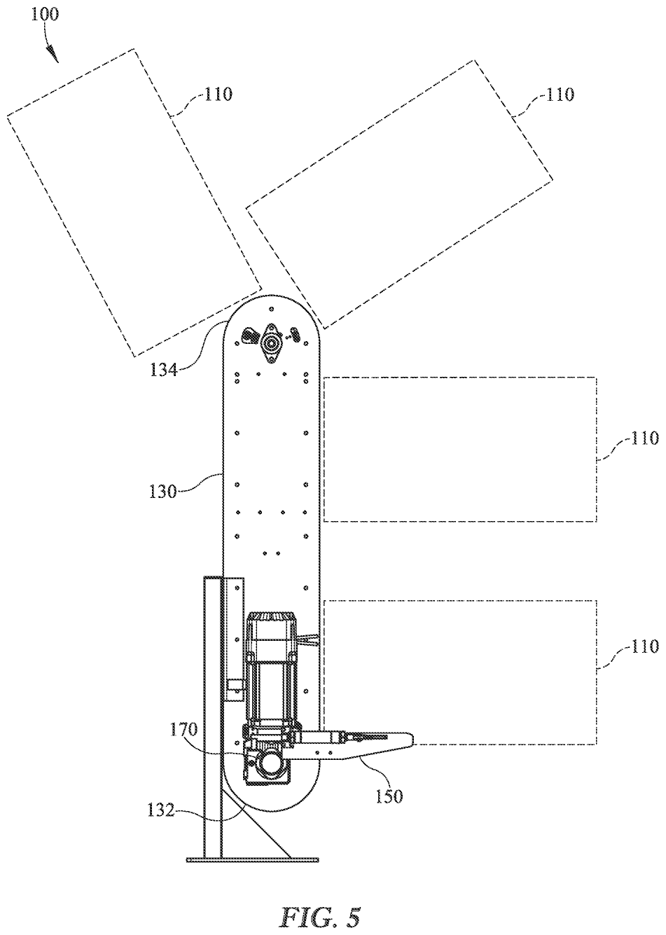

Referring first to FIG. 1, an exemplary tote tipping system 100 made in accordance with the present invention includes a frame 130 that extends from a first (lower) end 132 to a second (upper) end 134. A tote support fixture 150 is configured to selectively engage and secure a tote 110 (shown in FIG. 5). As discussed in detail below, a drive mechanism is configured to move the tote support fixture 150 between the first end 132 of the frame 130 and the second end 134 of the frame 130. Furthermore, and as further discussed below with reference to FIG. 5, when the tote support fixture 150 is at the first end 132 of the frame 130, the tote support fixture 150 is at a first angular orientation relative to the frame 130, and when the tote support fixture 150 is at the second end 134 of the frame 130, the tote support fixture 150 is at a second angular orientation relative to the frame 130.

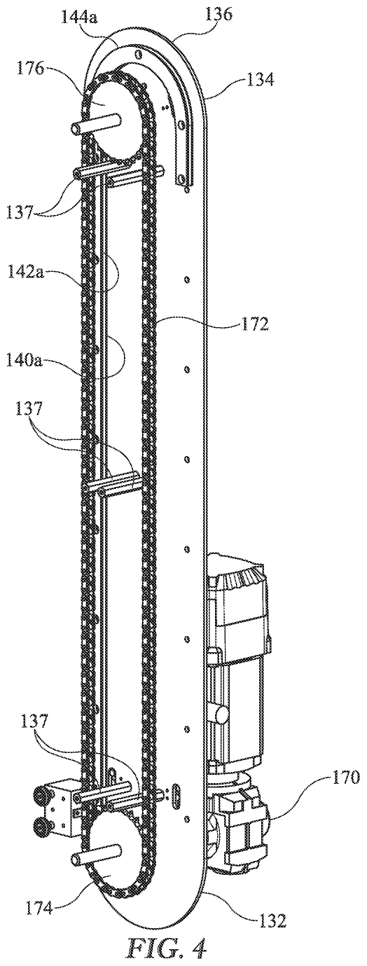

Referring still to FIG. 1, but now also to FIG. 4, in this exemplary embodiment, the frame 130 includes two parallel panels 136, 138. Multiple spacers 137 extend between the two panels 136, 138 to secure the panels 136, 138 and maintain their spacing. A rail 140a, 140b is attached to each respective panel 136, 138, with the rails 140a, 140b extending between the first end 132 and the second end 134 of the frame 130. In particular, the rails 140a, 140b are positioned between the two panels 136, 138.

As shown in FIGS. 1 and 4, the rails 140a, 140b each include a substantially straight section 142a, 142b that extends along the majority of the length of the frame 130, but the rails 140a, 140b further include a curved section 144a, 144b at the second end 134 of the frame 130. As further discussed below, this curved section 144a, 144b causes the tote support fixture 150 to rotate from the first angular orientation to the second angular orientation.

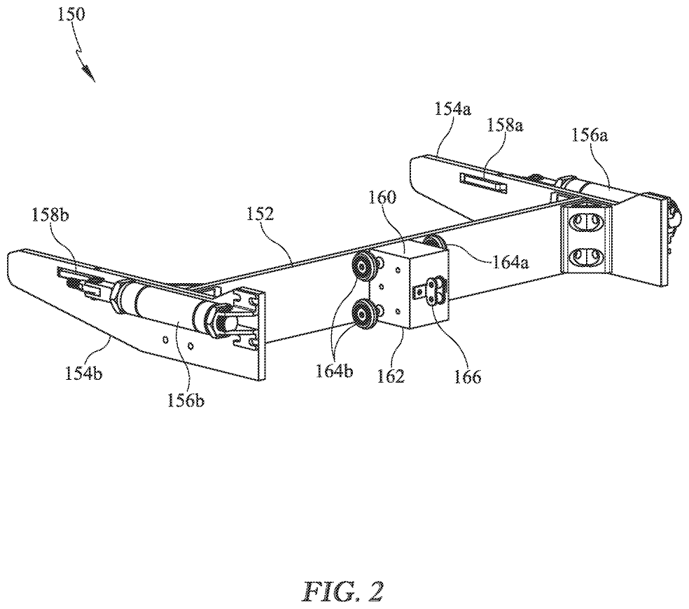

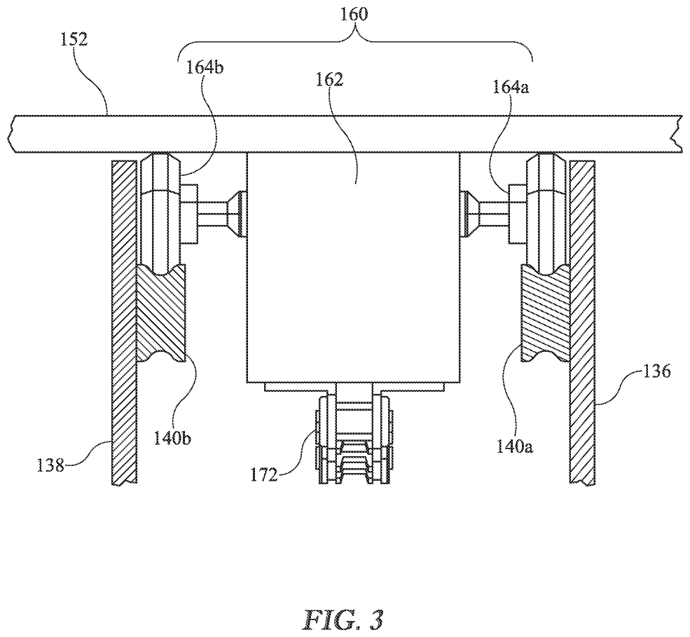

Referring now to FIGS. 1-4, but as perhaps best shown in FIGS. 2-3, a travelling connector 160 is configured to move alone and between the two rails 140a, 140b. The travelling connector 160 is connected to the tote support fixture 150, such that movement of the travelling connector 160 along the rails 140a, 140b causes the tote support fixture 150 to move between the first end 132 of the frame 130 and the second end 134 of the frame 130. In this way, the tote support fixture 150 moves along the rails 140, 140b.

Referring still to FIGS. 1-4 but with particular reference to FIGS. 2-3, the travelling connector 160 includes a main body 162 affixed to a crossbar 152 of the tote support fixture 150. Two wheels 164a (only one of which is visible in FIGS. 2-3) extend from a first side of the main body 162 and engage a first rail 140a on the first panel 136 of the frame 130. Likewise, two wheels 164b extend from a second side of the main body 162 and engage a second rail 140b on the second panel 138 of the frame 130. In particular, as shown in FIG. 3, the wheels 164a, 164b travel along a groove defined along the length of the rails 140a, 140b.

Referring still to FIGS. 1-4, but now with particular reference to FIGS. 1 and 4, the drive mechanism of the exemplary tote tipping system 100 includes a first gear 174 located at the first end 132 of the frame 130, a second gear 176 located at the second end 134 of the frame 130, a flexible member, e.g., a chain 172, extending around the first gear 174 and the second gear 176, and a motor 170 operably connected to the first gear 174. Additional details regarding operation of the drive mechanism are provided below.

Referring now specifically to FIGS. 1-2, as previously noted, the tote support fixture 150 includes a crossbar 152 operably connected to the drive mechanism by the travelling connector 160. Specifically, in this exemplary embodiment and as shown in FIG. 2, a link 166 is affixed to the travelling connector 160, and this link 166 is incorporated into the chain 172 of the drive mechanism. On each end of the crossbar 152, an arm 154a, 154b extends away from the crossbar 152 substantially perpendicular to the crossbar 152. A piston 156a, 156b is provided on each arm 154a, 154b, which actuates a finger 158a, 158b to selectively engage a tote (shown in FIG. 5). More specifically, when a tote is positioned between the two arms 154a, 154b, the pistons 156a, 156b cause the fingers 158a, 158b to rotate and engage the tote to secure the tote to the tote support fixture 150. Other configurations and means of securing totes are contemplated without departing from the spirit and scope of the present invention. For example, in some other embodiments, the arms are moveably connected to the crossbar and a piston is provided to close the arms inward to selectively engage a tote, e.g., by pivotally rotating the arms to affect a pinching and grasping function. In some embodiments, the tote includes features which are designed specifically for the tote support fixture to engage. In other embodiments, the tote support fixture is designed to accommodate any number of different tote designs.

Referring now to FIG. 5, as previously noted, when the tote support fixture 150 is at the first end 132 of the frame 130, the tote support fixture 150 is at a first angular orientation relative to the frame 130, and when the tote support fixture 150 is at the second end 134 of the frame 130, the tote support fixture 150 is at a second angular orientation relative to the frame 130.

In the first angular orientation, a tote 110 can be secured to the tote support fixture 150. Accordingly, and as shown in FIG. 5, when the tote 110 is at the first end 132 of the frame 130 and in the first angular orientation, the tote 110 is held substantially parallel to the ground. As previously noted, the tote 110 may be provided in an appropriate position to be secured by the tote support fixture 150 through a variety of means well known in the art, including, but not limited to conveyers, AGVs, and/or AMRs. A person of ordinary skill in the art would readily understand how to adapt the particular dimensions of the exemplary tote tipping system 100 to ensure the tote support fixture 150 is provided at an appropriate height and orientation to accept totes 110 depending on the intended use and implementation of the tote tipping system 100.

Once a tote 110 is secured by the tote support fixture 150, and as perhaps best shown in FIG. 4, the motor 170 rotates a first gear 174 causing the chain 172 to move around the first gear 174 and an second gear 176. In this way, the motor 170 can raise the tote support fixture 150 upwards along the frame 130. As the tote support fixture 150 reaches the top of the frame 130, the curved portions 144a, 144b of the rails 140a, 140b cause the tote support fixture 150 to rotate around the top of the frame 130. As shown in FIG. 5, a tote 110 secured by the tote support fixture 150 thus tips over the second end 134 of the frame 130 up to and including 180° until the contents of the tote are emptied. To this end, the tote support fixture 150 is preferably configured to maintain secure control of the tote 110 during the tipping operation.

Although not expressly shown, the tote 110 has an open top through which parcels are placed within the tote. Accordingly, in the second angular orientation, parcels fall out of the tote 110 under the force of gravity. To this end, it is contemplated that a chute, or other similar catching device would be positioned behind the tote tipping system 100 to catch the falling parcels and direct them to a preferred location, such as a bag. Once again, a person of ordinary skill in the art would readily understand how to adapt the particular dimensions of the exemplary tote tipping system 100 to ensure the tote support fixture 150 is provided at an appropriate height and orientation to tip a tote 110 and dispense parcels from the tote 110 to an specified location depending on the intended use and implementation of the tote tipping system 100.

Once the tote 110 is emptied, the motor 170 is reversed, allowing the chain 172 to lower the tote support fixture 150 and attached tote 110. In this way, the motor 170 of the exemplary tote tipping system 100 shown in FIGS. 1-4 operates to both raise the tote support fixture 150 and to rotate the tote support fixture 150 between the first angular orientation and the second angular orientation.

Although the a motor 170 in the exemplary tote tipping system 100 is operably connected to the first gear 174 at the first end 132 of the frame 130, in other embodiments, a motor may instead be connected to the second gear 176 at the second end 134 of the frame 130. Of course, additional gears and/or motors could also be included in the drive mechanism without departing from the spirit and scope of the present invention.

The exemplary tote tipping system 100 shown in FIGS. 1-5 includes a frame 130 which extends substantially vertically such that the second end 134 is immediately above the first end 132. While this configuration may be beneficial in some circumstances (i.e., to reduce the overall footprint of the tote tipping system 100), in other embodiments, the frame can extend at an angle such that the second end is horizontally offset from the first end.

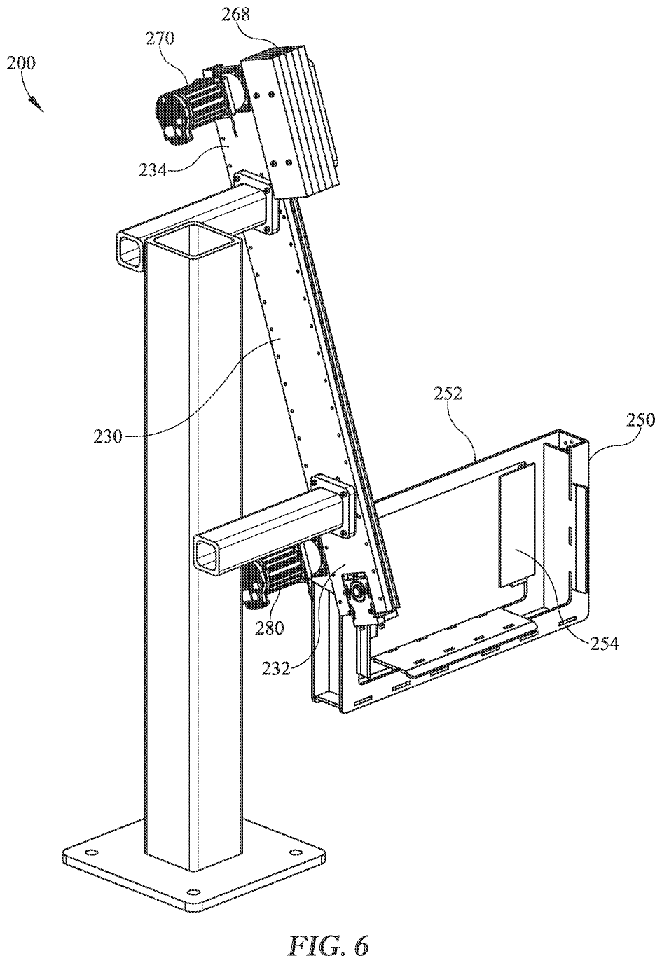

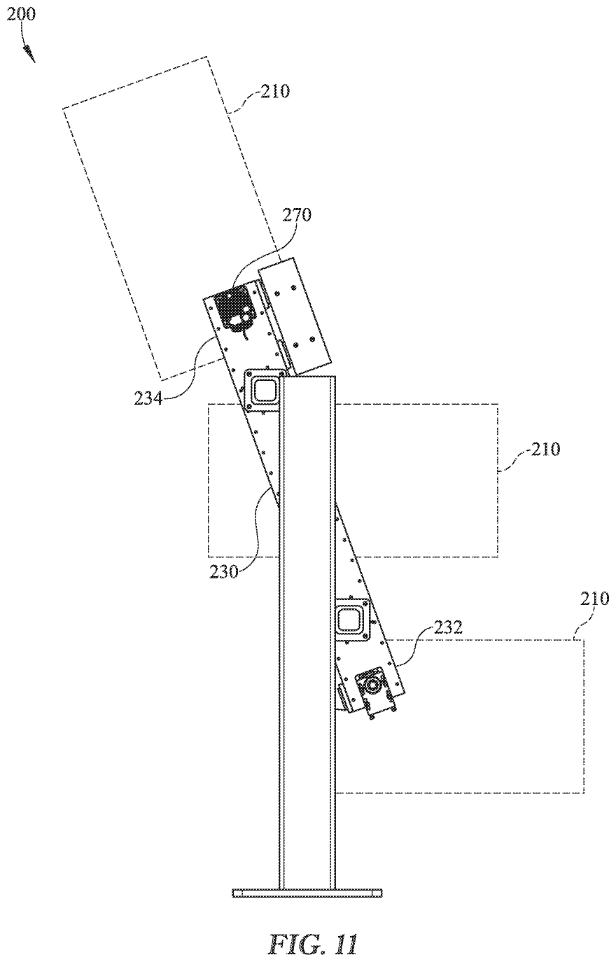

For example, and referring now to FIG. 6, a second exemplary tote tipping system 200 made in accordance with the present invention includes a frame 230 extending at an angle from a first (lower) end 232 to a second (upper) end 234 that is horizontally offset from the first end 232. A tote support fixture 250 is configured to selectively engage and secure a tote 210 (shown in FIG. 11). As discussed in detail below, a drive mechanism is configured to move the tote support fixture 250 between the first end 232 of the frame 230 and the second end 234 of the frame 230. Furthermore, and as further discussed below with reference to FIG. 11, when the tote support fixture 250 is at the first end 232 of the frame 230, the tote support fixture 250 is at a first angular orientation relative to the frame 230, and when the tote support fixture 250 is at the second end 234 of the frame 230, the tote support fixture 250 is at a second angular orientation relative to the frame 230.

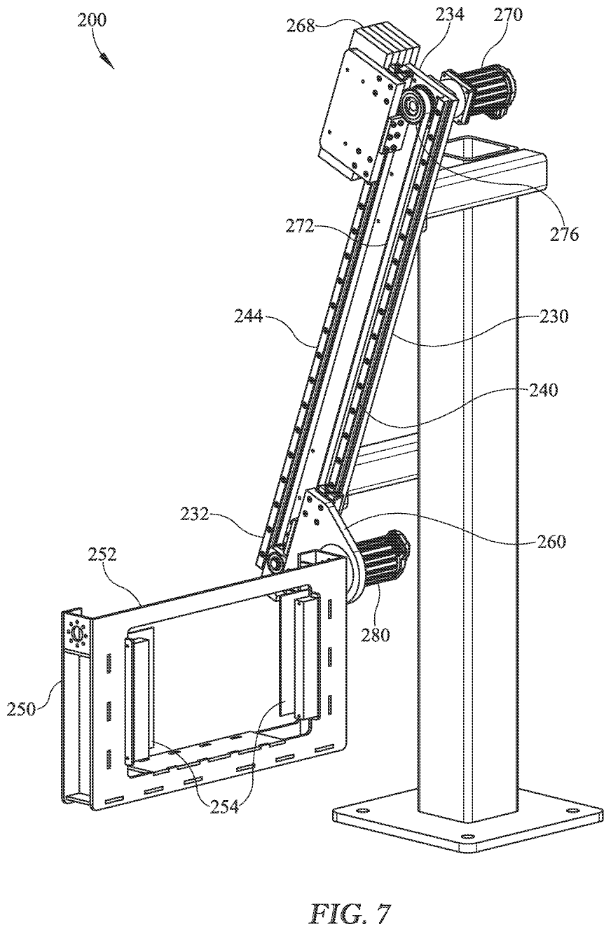

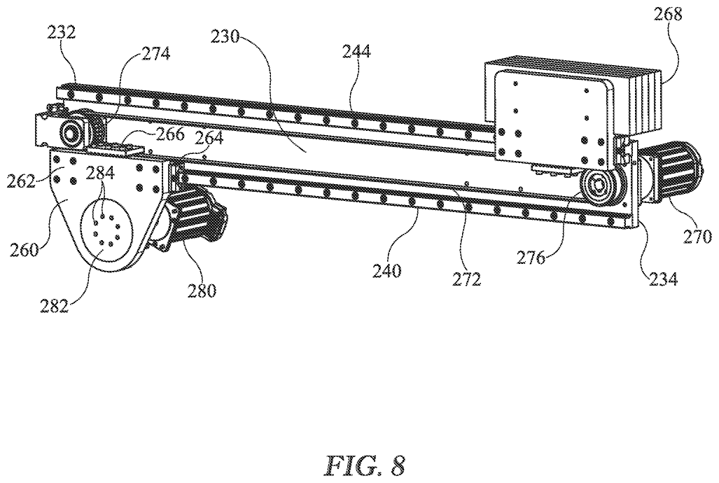

Referring now to FIGS. 7-8, the frame 230 of the second exemplary tote tipping system 200 includes a first rail 240 that extends between the first end 232 and the second end 234 of the frame 230, and a second rail 244 that extends between the first end 232 and the second end 234 of the frame 230 substantially parallel to the first rail 240. The tote support fixture 250 moves along the first rail 240, while a counterweight 268 moves along the second rail 244. More specifically, and similar to the tote tipping system 100 described above with reference to FIGS. 1-5, a travelling connector 260 is configured to move along the first rail 240 and as shown in FIG. 7, and the travelling connector 260 is connected to the tote support fixture 250 such that movement of the travelling connector 260 along the first rail 240 causes the tote support fixture 250 to move between the first end 232 of the frame 230 and the second end 234 of the frame 230.

Referring still to FIGS. 7-8, similar to the tote tipping system 100 described above with reference to FIGS. 1-5, in the second exemplary tote tipping system 200, the drive mechanism includes a first gear 274 located at the first end 232 of the frame 230, a second gear 276 located at the second end 234 of the frame 230, and a flexible member 272 that extends around the first gear 274 and the second gear 276. Unlike the tote tipping system 100 described above with respect to FIGS. 1-5, instead of a chain, in this exemplary embodiment, the flexible member is a belt 272, and a motor 270 is operably connected to the second gear 276 as opposed to the first gear 274. Of course, a motor could instead be connected to the first gear 274, and additional gears and/or motors could also be included without departing from the spirit and scope of the present invention.

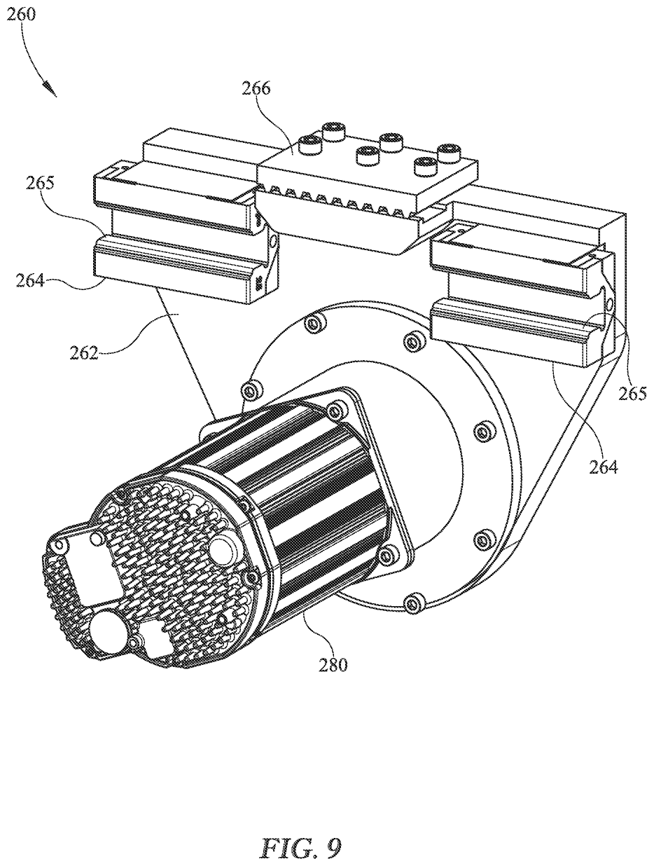

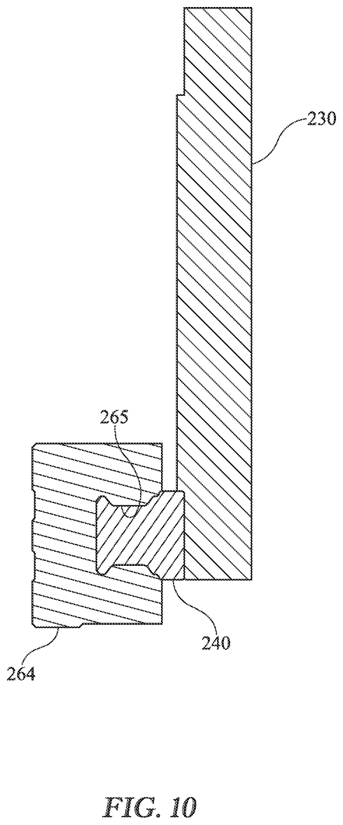

Referring still to FIGS. 7-8, but now also to FIGS. 9-10, the travelling connector 260 includes a main body 262 and guide members 264 that define a channel 265 which is configured to engage the first rail 240 and facilitate movement of the travelling connector 260 along the first rail 240. Furthermore, in this exemplary embodiment and as shown in FIG. 10, the first rail 240 and channel 265 have matching contours which maintain a secure connection between the travelling connector 260 and the first rail 240. The travelling connector 260 further includes a clamping member 266 to secure the travelling connector 260 to the belt 272.

Referring now to FIGS. 6-8, the second exemplary tote tipping system 200 further includes a counterweight 268 which is affixed to the belt 272 opposite from the traveling connector 260. The counterweight 268 is affixed to the belt 272 and moves along the second rail 244 in substantially the same manner as the travelling connector 260. Specifically, the counterweight 268 includes a clamping member to secure the counterweight to the belt 272, along with a guide member defining a channel configured to engage the second rail 244.

Referring now specifically to FIGS. 6-7, the tote support fixture 250 of the second exemplary tote tipping system 200 includes a substantially rectangular frame 252 and includes two electromagnets 254 which are used to selectively engage a metal plate included on a tote (shown in FIG. 11). It should be understood that a tote support fixture which utilizes a mechanical engagement, similar to the tote support fixture 150 described above with respect to FIGS. 1-2, could also be used with the second exemplary tote tipping system 200 without departing from the spirit and scope of the present invention. Likewise, the tote tipping system 100 described above with respect to FIGS. 1-5 could utilize electromagnets rather than a mechanical engagement without departing from the spirit and scope of the present invention.

Referring now to FIGS. 6-9, the second exemplary tote tipping system 200 further includes a second motor 280 affixed to the travelling connector 260, which is configured to rotate the tote support fixture 250 between the first angular orientation and the second angular orientation. In particular, and as shown in FIG. 8, the travelling connector 260 includes a round plate 282 which is rotated relative to the main body 262 of the travelling connector 260 by the motor 280. The tote support fixture 250 is connected to this plate 282 via a plurality of bolt holes 284 defined in the plate 282.

In operation, the second motor 280 travels along the first rail 240 with the travelling connector 260. As such, and referring now to FIG. 11, the first motor 270 is used to raise the tote support fixture 250 (shown in FIGS. 6-7) from the first end 232 of the frame 230 to the second end 234 of the frame, and the second motor 280 (shown in FIGS. 6-9) is then used to rotate the tote support fixture 250 between the first angular orientation and the second angular orientation. In some exemplary implementations, the second motor 280 rotates the tote support fixture 250 after it is at the second end 234 of the frame 230, causing the attached tote 210 to tip over up to and including 180° until the contents of the tote 210 are emptied. To this end, the tote support fixture 250 is preferably configured to maintain secure control of the tote 210 during the tipping operation. Once the tote 210 is emptied, the second motor 280 and the first motor 270 are reversed to lower the tote support fixture 250 and attached tote 210. Of course, the second motor 280 can rotate the tote support fixture 250 independent of the linear movement of the travelling connector 260.

A person of ordinary skill in the art would readily understand how to adapt the particular dimensions of the exemplary tote tipping system 200 to ensure the tote support fixture 250 is provided at an appropriate height and orientation to accept totes 210, and also to tip a tote 210 and dispense parcels from the tote 210 to an specified location depending on the intended use and implementation of the tote tipping system 200.

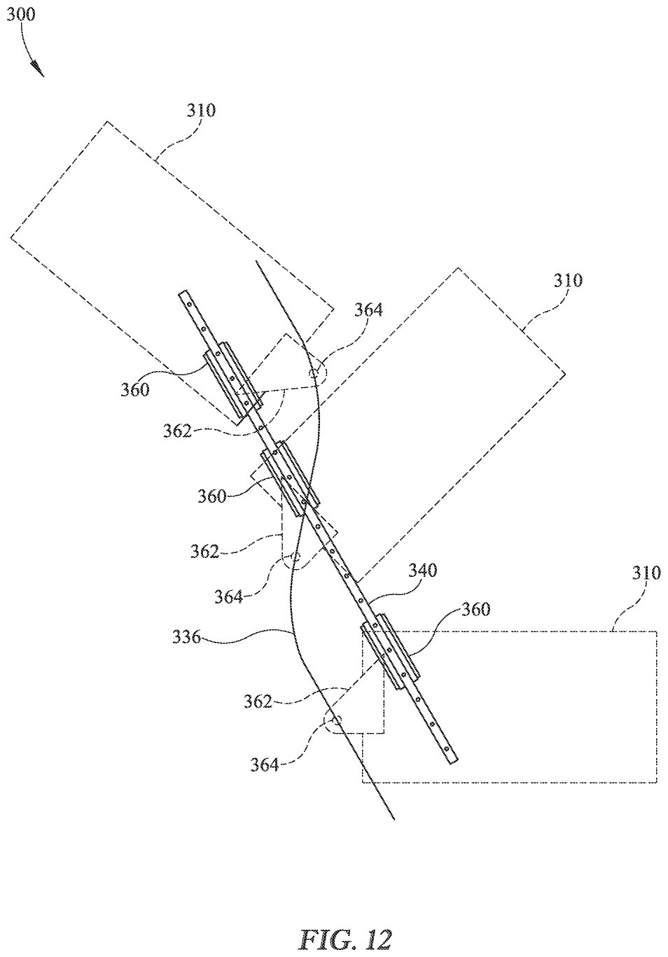

Referring now to FIG. 12, a third exemplary tote tipping system 300 operates similar to the first exemplary tote tipping system 100 described above with respect to FIGS. 1-5, in that a single motor functions to both raise and tip the tote 310. More specifically, although not all portions of the exemplary tote tipping system 300 are shown in FIG. 12, the system 300 includes a frame (not shown) extending upward from the floor with a substantially linear rail 340 extending at an angle. A travelling connector 360 is configured to move along the rail 340, causing a tote support fixture (not shown) to move between the first end of the frame and the second end of the frame. However, unlike the first exemplary tote tipping system 100, the third exemplary tote tipping system 300 shown in FIG. 12 includes a triangular bracket 362 which is mounted for rotation with respect to the travelling connector 360 and is operably connected to the tote support fixture. The bracket 362 is configured to rotate the tote support as the travelling connector 360 is raised upward along the rail 340. Specifically, a cam follower 364 is included at one corner of the triangular bracket 358, and a serpentine slot (represented by line 336) is defined in the frame. As the travelling connector 360 moves along the rail 340, the cam follower 364 moves along the serpentine slot 336, causing the tote support fixture (not shown) and connected tote 310 to rotate from the first angular orientation to the second angular orientation. Other means of causing the triangular bracket to rotate are also possible including, but not limited to, the use of a serpentine rail instead of the cam follower and serpentine slot 336 described above, without departing from the spirit and scope of the present invention.

It should be readily understood that all exemplary embodiments of the present invention described above allow for one to tailor the vertical motion and rotational motion independently. This is of particular importance when the tote tipping system is intended to have a small footprint because it allows for tighter packaging and avoidance of other obstacles. Similarly, by making a large portion of the vertical movement before the rotation, the cycle time can be compressed which improves speed.

One of ordinary skill in the art will recognize that additional embodiments and implementations are also possible without departing from the teachings of the present invention. This detailed description, and particularly the specific details of the exemplary embodiments and implementations disclosed herein, are given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A tote tipping system, comprising:
a frame extending from a first end to an second end;
a tote support fixture configured to selectively engage and secure a tote; and
a drive mechanism configured to move the tote support fixture between the first end of the frame and the second end of the frame;
wherein, when the tote support fixture is at the first end of the frame, the tote support fixture is at a first angular orientation relative to the frame, the first angular orientation allowing a tote to be secured to the tote support fixture; and
wherein, when the tote support fixture is at the second end of the frame, the tote support fixture is at a second angular orientation relative to the frame, the second angular orientation allowing parcels to fall out of the tote.

2. The tote tipping system of claim 1, wherein the frame includes a rail extending between the first end and the second end of the frame, and wherein the tote support fixture moves along the rail.

3. The tote tipping system of claim 2, wherein the rail is substantially straight along a majority of a length of the frame.

4. The tote tipping system of claim 2, wherein the rail includes a curved section at the second end of the frame, such that, as the tote support fixture moves along the curved section of the rail, the tote support fixture rotates from the first angular orientation to the second angular orientation.

5. The tote tipping system of claim 2, and further comprising a travelling connector interposed between the tote support fixture and the frame, wherein the travelling connector engages and moves along the rail.

6. The tote tipping system of claim 5, wherein the travelling connector includes a guide member defining a channel configured to engage the rail.

7. The tote tipping system of claim 6, and further comprising a motor affixed to the travelling connector, the motor being configured to rotate the tote support fixture between the first angular orientation and the second angular orientation.

8. The tote tipping system of claim 5, wherein the travelling connector includes a main body with wheels extending from the main body, and wherein the wheels are configured to travel along one or more grooves defined along a length of the rail.

9. The tote tipping system of claim 5,
wherein the frame includes two parallel panels;
wherein the rail includes a first rail affixed to a first of the two parallel panels and a second rail affixed to a second of the two parallel panels, with the first rail and the second rail positioned between the two parallel panels; and
wherein the travelling connector is located between the first rail and the second rail.

10. The tote tipping system of claim 5, wherein the frame defines a serpentine slot, and the travelling connector includes a cam follower configured to engage the serpentine slot, such that, as the travelling connector moves from the first end of the frame to the second end of the frame, the cam follower moves along the serpentine slot, causing the tote support fixture to rotate from the first angular orientation to the second angular orientation.

11. The tote tipping system of claim 2, and further comprising a motor configured to rotate the tote support fixture between the first angular orientation and the second angular orientation.

12. The tote tipping system of claim 11, wherein the motor moves along the rail with the tote support fixture.

13. The tote tipping system of claim 11, wherein the motor rotates the tote support fixture after the tote support fixture is at the second end of the frame.

14. The tote tipping system of claim 1,
wherein the drive mechanism includes
a first gear located at the first end of the frame,
a second gear located at the second end of the frame,
a flexible member extending around and operably connecting the first gear and the second gear, and
a motor operably connected to at least one of the first gear and the second gear to rotate the at least one of the first gear and the second gear and cause the flexible member to move;
wherein the tote support fixture is affixed to the flexible member, such that the tote support fixture travels with the flexible member between the first end of the frame and the second end of the frame.

15. The tote tipping system of claim 14, wherein the flexible member is selected from the group consisting of a chain and a belt.

16. The tote tipping system of claim 14, and further comprising a counterweight affixed to the flexible member opposite from the tote support fixture.

17. The tote tipping system of claim 16,
wherein the frame includes a first rail extending between the first end and the second end of the frame, and a second rail extending between the first end and the second end of the frame; and
wherein the tote support fixture moves along the first rail and the counterweight moves along the second rail.

18. The tote tipping system of claim 1, wherein the frame extends at an angle, such that the second end is horizontally offset from the first end.

19. The tote tipping system of claim 1, wherein the frame extends vertically, such that the second end is immediately above the first end.

20. A tote tipping system, comprising:
a frame extending from a first end to a second end;
a first gear located at the first end of the frame;
a second gear located at the second end of the frame;
a flexible member extending around and operably connecting the first gear and the second gear;
a motor operably connected to at least one of the first gear and the second gear to rotate the at least one of the first gear and the second gear and cause the flexible member to move;
a rail extending between the first end and the second end of the frame;
a travelling connector configured to engage and move along the rail, the travelling connector affixed to the flexible member, such that the travelling connector travels with the flexible member between the first end of the frame and the second end of the frame;
a tote support fixture affixed to the travelling connector, the tote support fixture configured to selective engage and secure a tote;
a second motor affixed to the travelling connector, the motor being configured to rotate the tote support fixture between a first angular orientation and a second angular orientation;
wherein, when the tote support fixture is at the first end of the frame, the tote support fixture is at the first angular orientation relative to the frame, the first angular orientation allowing a tote to be secured to the tote support fixture; and
wherein, when the tote support fixture is at the second end of the frame, the tote support fixture is at the second angular orientation relative to the frame, the second angular orientation allowing parcels to fall out of the tote.
